(19) United States
(12) Patent Application Publication
(10) Pub. No.: US 2020/0088477 A1
(43) Pub. Date: Mar. 19, 2020

(54) HEAT EXCHANGER UNIT

(71) Applicant: Mahle International GmbH, Stuttgart (DE)

(72) Inventors: Richard Bruemmer, Stuttgart (DE); Michael Bucher, Berlin (DE); Christoph Fiala, Potsdam (DE); Klaus Irmler, Tuebingen (DE); Hannes Marlok, Leonberg (DE); Holger Oechslen, Stuttgart (DE)

(21) Appl. No.: 16/575,351

(22) Filed: Sep. 18, 2019

(30) Foreign Application Priority Data
Sep. 19, 2018 (DE) 102018215981.5

(51) Int. Cl. F28F 9/02; F28D 15/02; F01P 3/22; B60H 1/00

(52) U.S. Cl. CPC F28F 9/0231; B60H 1/00899; F01P 3/22; F28D 15/0266

(57) ABSTRACT

A heat exchanger unit for a fluid circuit of a motor vehicle includes a plurality of fluid connections for a through-flow of a working fluid, a fluid distributor fluidically connected to the fluid connections, and a fluid connector fluidically connected to the fluid connections. The fluid distributor is structured and arranged to distribute the working fluid among the fluid connections, and the fluid collector is structured and arranged to collect the working fluid after flowing through the fluid connection. At least a portion of the fluid distributor and/or the fluid collector includes a surge tank for the working fluid.

### CROSS-REFERENCE TO RELATED APPLICATION

This application claims priority to German Application No. DE 10 2018 215 981.5 filed on Sep. 19, 2018, the contents of which are hereby incorporated by reference it its entirety.

### TECHNICAL FIELD

The present invention relates to a heat exchanger unit for a fluid circuit of a motor vehicle.

### BACKGROUND

Heat exchanger units are used in fluid circuits, especially in coolant and/or refrigerant circuits of motor vehicles in order to achieve a heat exchange between a working fluid, which flows through the heat exchanger unit, and another fluid, such as the ambient air of the heat exchanger unit. In such a fluid circuit a cooling or also a heating of partial regions of the motor vehicle can be accomplished with a suitable design.

Such a fluid circuit may comprise a first heat exchanger unit and a second heat exchanger unit, wherein the first heat exchanger unit can be designed as a condenser unit for condensing the working fluid and the second heat exchanger unit as an evaporator unit for evaporating the working fluid. Downstream from the condenser unit there may be provided a surge tank, in which liquid working fluid gathers. Downstream from the surge tank there may be provided in the fluid circuit a filter device for the filtration of the working fluid and a fluid delivery device for delivering the working fluid. Downstream from the fluid delivery device there may be provided the evaporator unit, while downstream from the evaporator unit an expander unit is provided for expanding the gaseous working fluid. Downstream from the expander unit comes the condenser unit once more. The components of such a fluid circuit may be fluidically interconnected by suitable fluid lines.

The drawback to conventional heat exchangers is often their relatively complex and large construction.

The problem which the present invention proposes to solve is to modify a heat exchanger unit of the kind mentioned above so that a more compact and cost-effective design of a fluid circuit of a motor vehicle is made possible.

This problem is solved according to the invention by the subject matter of the independent claim(s). Advantageous embodiments are the subject matter of the dependent claims.

### SUMMARY

The present invention is based on the general notion that at least one partial region of the heat exchanger unit forms the surge tank and thus a separate surge tank is no longer required. The heat exchanger unit according to the invention provides for a fluid distributor and a fluid collector, wherein the fluid distributor (entry box) and the fluid collector (exit box) are arranged at a distance from each other and are fluidically connected together by a plurality of fluid connections (heat exchanger block). The working fluid may flow across a fluid inlet into the fluid distributor, while the fluid distributor distributes the working fluid among the fluid connections, e.g., flat tubes. The working fluid may flow through the fluid connections, undergoing a change in its state of aggregation at least partially. After flowing through the fluid connections, the working fluid of the individual fluid connections can be collected or merged together in the fluid collector and be provided across a fluid outlet to a fluid delivery device. The fluid distributor as well as the fluid collector may each be designed as a box and/or cylinder, wherein the fluid distributor and the fluid collector may be connected to the fluid connections in fluid-tight manner for example by soldered connections.

The fluid connections may be, for example, a plurality of mutually spaced flat tubes, between which rib elements may be arranged. One portion of the fluid distributor and/or the fluid collector forms a surge tank for the working fluid. The surge tank may be designed as an integral component of the fluid distributor and/or the fluid collector. In this surge tank, the liquid working fluid may collect, wherein the surge tank may be designed such that a pressure equalization is realized in the fluid circuit. The advantage in the configuration according to the invention is that the number of separate components is reduced and fluid lines between the components of the fluid circuit can be economized. This makes possible a more cost-effective and compact design of the fluid circuit or the heat exchanger.

In another advantageous embodiment of the solution according to the invention it is provided that the heat exchanger unit is designed as a direct or indirect condenser unit. The heat exchanger unit is designed as a direct condenser unit when the working fluid upon flowing through the fluid connections is at least partly condensed and thereby releases thermal energy, while the surrounding air of the fluid connections takes up the released thermal energy of the working fluid. It may be provided that the heat exchanger unit is situated in the frontal area of a motor vehicle, in order to make possible an adequate removal of the heated ambient air. The heat exchanger unit is designed as an indirect condenser unit when the working fluid upon flowing through the fluid connections is at least partly condensed and thereby releases thermal energy, while a working medium of a second fluid circuit takes up the released thermal energy of the working fluid. The second fluid circuit may comprise a direct condenser unit, which can be situated for example in the frontal area of a motor vehicle. In an indirect condenser unit, the surge tank may have a cavity in the lower region to ensure an exchange of the working fluid between a condenser of the condenser unit and the surge tank, while the surge tank may have a pressurized air port in the upper region to regulate the system pressure. It may be provided that this surge tank is formed as a deep-drawn piece.

In one advantageous modification of the solution according to the invention it is provided that the fluid distributor has a fluid inlet for the inflow of the working fluid, while the fluid collector has a fluid outlet for the outflow of the working fluid, and at least a portion of the fluid collector forms the surge tank for the working fluid. In order for the working fluid in the liquid state to gather substantially in the surge tank, the fluid distributor has a cross section having a maximum value at the fluid inlet and decreasing with increasing distance from the fluid inlet. The decrease in the cross section of the fluid distributor may be a linear and/or quadratic and/or cubic and/or constant and/or nonconstant function.

In another advantageous embodiment of the solution according to the invention it is provided that the fluid collector is formed from a cover and a bottom, wherein between the cover and the bottom there is arranged a substantially fluid-tight membrane. The membrane may be stretched between the cover and the bottom. The bottom may be formed from a metallic material, and the cover may be formed from a plastic material. It may also be provided that a lock connection is formed between the cover and the bottom, so that the cover may be clipped onto the bottom.

Between the cover and the membrane there is formed a first spatial region, wherein between the membrane and the bottom there is formed a second spatial region, wherein the second spatial region is fluidically connected to the fluid connections. At least one partial region of the second spatial region may form a collecting volume of the surge tank.

The membrane can be formed from an elastic material, where its elasticity together with the dimensions of the fluid collector may be designed such that the second spatial region depending on the distension of the membrane may have a capacity between 2 to 7 litres, especially between 3 and 5 litres. The first spatial region forms a gas cushion, having a restoring effect on the membrane. Together with the elasticity of the membrane and the gas cushion, a pressure equalization is made possible, so that an optimal capacity of the second spatial region is provided depending on the system pressure in the heat exchanger unit.

In one advantageous modification of the solution according to the invention it is provided that in the second spatial region between the membrane and the bottom there is provided a fluid-permeable separating element, wherein between the separating element and the bottom there is formed a pre-spatial region into which the membrane does not penetrate. It may be provided that the pre-spatial region has a capacity which is less than 2 litres, especially less than 0.5 litres. The separating element may be designed such that the working fluid can overcome the separating element with the least possible flow resistance, the separating element being designed such that the membrane under a large negative pressure does not block the fluid connections and/or the fluid outlet. The separating element may be formed for example as a grid.

In another advantageous embodiment of the solution according to the invention it is provided that the liquid working fluid in the second spatial region has a liquid level which lies in a predefined level range during normal operation of the heat exchanger unit. Upon partial filling of the second spatial region with the working fluid, the second spatial region can be divided into a lower region and an upper region, the lower region being situated below the liquid surface of the working fluid and the upper region above the liquid surface of the working fluid. The lower region is thus filled with the liquid working fluid and gaseous working fluid may likewise be present in the upper region. The liquid level is the distance of the liquid surface from the lowest lying point of the lower region still in direct fluidic contact with the working fluid. By this definition, for example, this can only be an inner wall used to bound the second spatial region. The level range may be defined by a minimum liquid level and a maximum liquid level, and a fluctuation of the liquid level within the level range may be viewed as normal operation of the heat exchanger unit. The maximum liquid level may correspond to a complete filling of the second spatial region with liquid working fluid. It is provided that the fluid outlet is situated below the level range or below the minimum liquid level. If technical problems arise during the condensing of the working fluid in the heat exchanger unit, the working fluid will not condense sufficiently, so that the liquid level drops below the minimum liquid level, and the space above the fluid outlet is filled with gaseous working fluid until the fluid outlet likewise lies in the gaseous region and thus gaseous working fluid flows to the delivery device.

It may be provided that downstream from the fluid outlet there is provided a fluid delivery device, which can only deliver liquid working fluid. If the condensation of the working fluid is inadequate, the fluid delivery device can no longer take in any liquid working fluid, so that the delivery performance of the fluid delivery device breaks down and the mass flow in the fluid circuit is interrupted. In this way, no more thermal energy is transferred to the system, so that no critical pressure is produced in the low-pressure range of the system. Thus, the fluid circuit is shut off upon technical problems by the heat exchanger unit according to the invention, without the need for an additional low-pressure safety system. In this way, costs can be saved and the construction of the fluid circuit is further simplified.

In one advantageous modification of the solution according to the invention it is provided that the fluid collector has an additional condenser unit, wherein the additional condenser unit is situated in an installed position of the heat exchanger unit above the fluid outlet. The additional condenser unit may be provided in the surge tank or at the surge tank, wherein the additional condenser unit may be designed for example as a plate type heat exchanger. Gaseous working fluid flows into the additional condenser unit and is condensed there. It may also be provided that the additional condenser unit comprises a tank, which is fluidically connected to a cooling pipe, the cooling pipe being led through the surge tank. The cooling pipe may be outfitted with cooling fins. Using the additional condenser, disturbances in the condensation of the working fluid may be equalized in a certain range, so that for example the driver of the motor vehicle can seek out a repair shop.

It is also conceivable for the fluid collector to have a safety valve, so that upon a critical excess pressure in the heat exchanger unit gaseous working fluid is diverted to the surroundings, if the halting of the delivery of the fluid delivery device and the additional condenser unit fail or do not achieve the desired effect of pressure reduction.

In another advantageous embodiment of the solution according to the invention it is provided that the additional condenser unit has a circuit that is filled with a working medium. The working medium may be water, for example.

In one advantageous modification of the solution according to the invention it is provided that the additional condenser unit has a tank with a working medium, wherein the working medium, such as water, only flows once through the additional condenser unit after a switching process and then escapes into the surroundings. The switching process may be thermally triggered at a certain limit temperature, accompanied by a certain limit pressure. The limit temperature may lie in the range of 90° C. to 120° C. This may occur for example by the melting or change in the viscosity of wax, a thermoplastic, or an oil, but also by the excess pressure itself, for example by using an excess pressure valve, whereby a cover of a membrane yields.

A flushing of the additional condenser unit with the working medium after the switching process may be accomplished in that the tank is situated above a condenser of the additional condenser unit or the tank is prestressed. The tank may be prestressed by an elastic housing or by a compressible medium in the tank. The advantage to this is that the additional condenser unit is used only in system-critical situations and it has a simple and cost-effective design. It may be provided that the tank is designed as an interchangeable working medium cartridge, which can be releasably connected by screw or plug-in connection to the additional condenser unit, in order to enable a restoring of the safety function after a switching process.

Moreover, the invention relates to a fluid circuit of a motor vehicle, wherein the fluid circuit has a heat exchanger unit according to the invention, wherein a fluid delivery device is provided downstream from the fluid outlet. This fluid delivery device is designed basically solely for the delivery of liquid working fluid. Upon attempting to deliver a gaseous working fluid, the mass flow breaks down. Break down is understood to mean that the mass flow or the delivery performance diminishes with increasing proportion of gaseous working fluid, whereby substantially no more mass flow exists at latest when there is present a completely gaseous working fluid.

Downstream from the fluid outlet there may be provided in the fluid circuit a filter device for the filtration of the working fluid and a fluid delivery device for delivering the working fluid. Downstream from the fluid delivery device there may be provided the evaporator unit, while downstream from the evaporator unit an expander unit is provided for expanding the working fluid. Downstream from the expander unit comes the condenser unit once more. The components of such a fluid circuit may be fluidically interconnected by suitable fluid lines. The evaporator unit may take up waste heat from an internal combustion engine during the evaporation.

Moreover, the invention relates to a method for operating a fluid circuit according to the invention, wherein the mass flow delivered by the fluid delivery device breaks down upon inadequate condensation of the working fluid in the heat exchanger unit, wherein upon breakdown of the mass flow the operation of the fluid circuit and/or the motor vehicle is halted.

One advantageous modification of the method provides that, upon inadequate condensation of the working fluid in the heat exchanger unit, the liquid level drops so much below the fluid outlet that the fluid delivery device substantially takes in gaseous working fluid.

Further major features and benefits of the invention will emerge from the dependent claims, from the drawings, and from the corresponding description of the figures with the aid of the drawings.

Of course, the features mentioned above and yet to be discussed below may be used not only in the particular indicated combination, but also in other combinations or standing alone, without leaving the scope of the present invention.

Preferred exemplary embodiments of the invention are represented in the drawings and shall be explained more closely in the following description, where the same reference numbers pertain to the same or similar or functionally equivalent components.

### BRIEF DESCRIPTION OF THE DRAWINGS

The drawings show, each case schematically,

FIG. 1 an internal combustion engine with a fluid circuit according to the invention,

FIG. 2 a fluid circuit according to the invention with additional condenser unit,

FIG. 3 a first embodiment of an indirect heat exchanger unit according to the invention,

FIG. 4 a second embodiment of an indirect heat exchanger unit according to the invention,

FIG. 5 a third embodiment of an indirect heat exchanger unit according to the invention.

### DETAILED DESCRIPTION

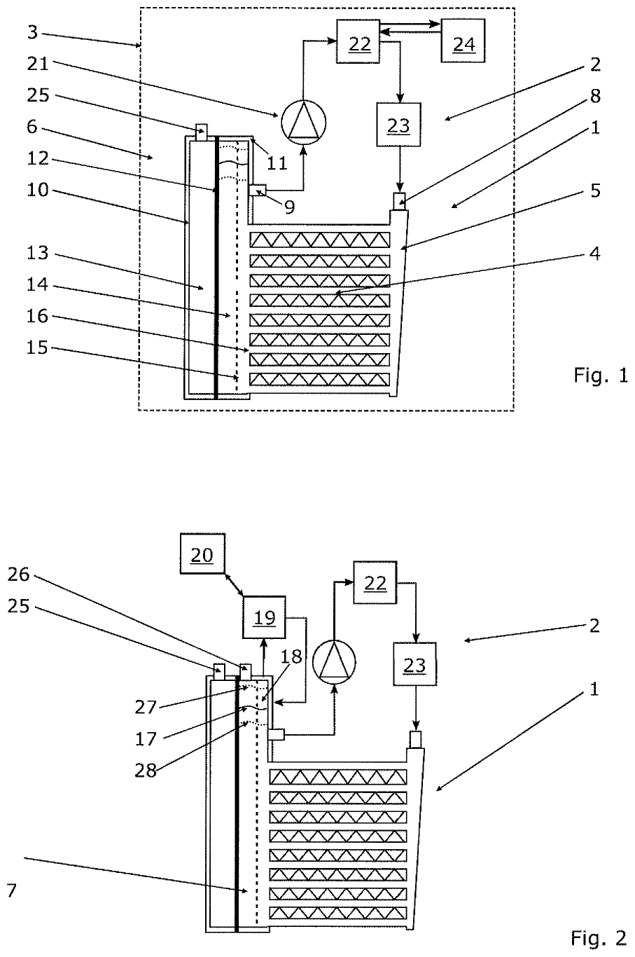

FIG. 1 shows symbolically a motor vehicle 3, having a fluid circuit 2 and an internal combustion engine 24, the fluid circuit 2 being thermally coupled to the internal combustion engine 24 in such a way that the fluid circuit 2 removes waste heat of the internal combustion engine 24 into the surroundings of the motor vehicle 3. In FIG. 1-5, fluid lines are marked by arrows, joining together each time two components of the motor vehicle 3, the arrow direction representing the flow direction of a working fluid in the fluid circuit 2.

The fluid circuit 2 comprises a heat exchanger unit 1, a fluid delivery device 21, an evaporator unit 22 and an expander unit 23. These components are interconnected by fluid lines in such a way that they form the closed fluid circuit 2, in which the working fluid is circulating.

The heat exchanger unit 1 comprises a fluid distributor 5 (entry box) and a fluid collector 6 (exit box), the fluid distributor 5 and the fluid collector 6 being spaced apart from each other. The fluid distributor 5 and the fluid collector 6 are fluidically connected by a plurality of fluid connections 4. The fluid connections 4 may be formed as flat tubes, for example. Between the fluid connections 4 there may be provided rib elements, in order to maximize the surface contributing to the heat exchange.

The fluid distributor 5 has a fluid inlet 8, through which the working fluid can flow into the fluid distributor 5. As indicated in FIG. 1, the cross section of the fluid distributor 5 decreases with increasing distance from the fluid inlet 8.

The working fluid coming from the expander unit 23 is substantially gaseous and it flows through the fluid connections 4, becoming cooled and condensing. The thermal energy released by the working fluid is discharged via the fluid connections 4 to the surroundings of the heat exchanger unit 1.

The fluid collector 6 comprises a cover 10 and a bottom 11, wherein between the cover 10 and the bottom 11 there is arranged a fluid-tight and elastic membrane 12. Between the cover 10 and the membrane 12 there is formed a first spatial region 13, while between the membrane 12 and the bottom 11 there is formed a second spatial region 14, the second spatial region 14 being fluidically connected to the fluid connections 4. In the second spatial region 14 there is provided a separating element 15, which is permeable to the working fluid and impermeable to the membrane 12. The separating element 15 forms, together with the bottom 11, a pre-spatial region 16 into which the membrane 12 cannot penetrate. In this way, the membrane 12 is prevented from closing the fluid connections 4 or a fluid outlet 9 in event of a negative pressure. The separating element 15 may be formed for example as a grid element. Depending on the system pressure, the membrane 12 stretches in the direction of the cover 10 or in the direction of the bottom 11.

The liquid working fluid gathers in the surge tank 7, which is formed by the membrane 12 and the bottom 11. As shown in FIG. 2, the liquid working fluid in normal operation of the heat exchanger unit 1 has a liquid level 17 lying in a level range 18. The level range 18 is indicated in FIG. 1 and FIG. 2 by dotted wavy lines. The level range 18 may be defined by a minimum level 28 and a maximum level 27. The liquid level 17 is indicated by a solid wavy line. The fluid outlet 9 is situated below the level range 18, wherein it may be provided that the fluid outlet 9 is situated at the lower region of the level range 18.

If the liquid level 17 drops significantly below the level range 18, i.e., below the minimum level 28, the fluid delivery device 21 can no longer take in any liquid working fluid, but only gaseous working fluid. Since the fluid delivery device 21 is designed so that it can only deliver liquid working fluid, the mass flow of the working fluid in the fluid circuit 2 breaks down, so that the fluid circuit 2 shuts itself off.

The fluid circuit 2 in FIG. 2 differs from the fluid circuit 2 in FIG. 1 in that an additional condenser unit 19 has been assigned to the surge tank 7, the fluid connections between the surge tank 7 and the additional condenser unit 19 being situated above the liquid level 17 and/or above the fluid outlet 9. Hence, only gaseous working fluid can flow into the additional condenser unit 19 and become condensed there. Upon condensation of the working fluid, a working medium of the additional condenser unit 19 is evaporated. The additional condenser unit 19 may comprise a tank 20 in which the working medium is kept ready for a repeat or even a onetime use. In addition, the surge tank 7 comprises a safety valve 26, via which the gaseous working fluid can be discharged to the surroundings at critical system pressure.

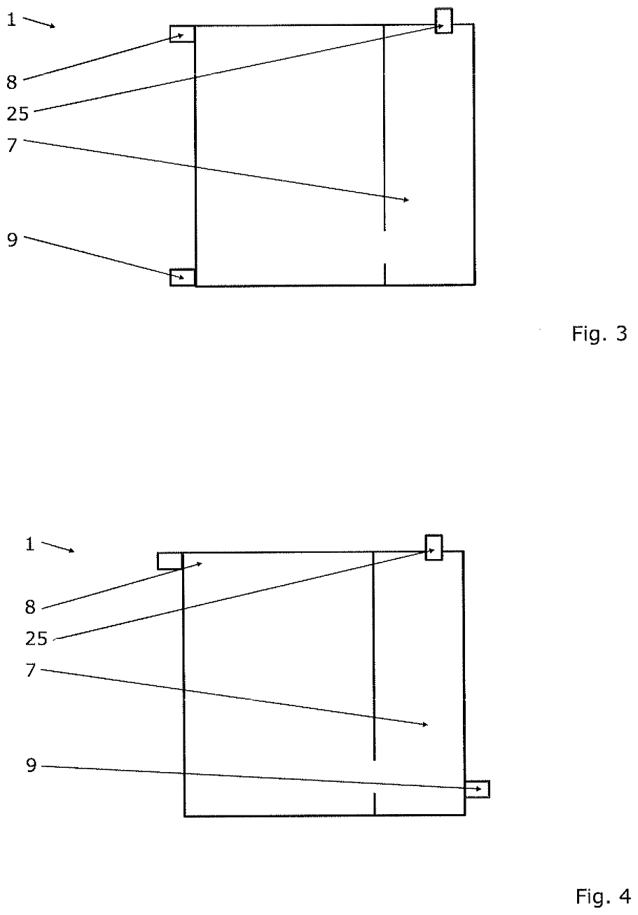

FIG. 3 shows an embodiment of an indirect heat exchanger unit 1 according to the invention, the heat exchanger unit 1 having a fluid inlet 8 and a fluid outlet 9, between which the working fluid condenses, the condensed working fluid being partly collected in the surge tank 7. The surge tank 7 is fluidically connected by a cavity to a condenser of the heat exchanger unit 1. The surge tank 7 has a compressed air port 25, which can be designed to control the system pressure.

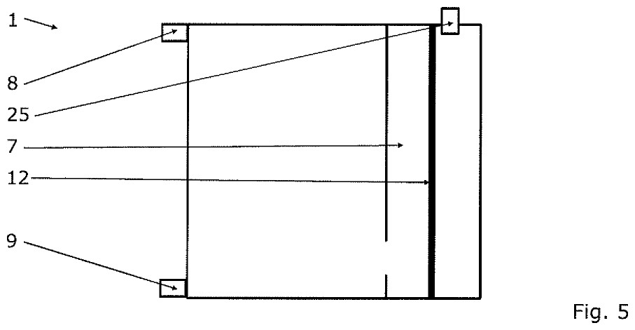

FIG. 4 shows an embodiment of an indirect heat exchanger unit 1 according to the invention, where the fluid outlet 9 is arranged at the surge tank 7. FIG. 5 shows another embodiment of an indirect heat exchanger unit 1 according to the invention, where an elastic membrane 12 is arranged in the surge tank 7.

1. A heat exchanger unit for a fluid circuit of a motor vehicle, comprising:
a plurality of fluid connections for a through-flow of a working fluid,
a fluid distributor fluidically connected to the plurality of fluid connections, structured and arranged to distribute the working fluid among the plurality of fluid connections,
a fluid collector fluidically connected to the plurality of fluid connections, structured and arranged to collect the working fluid after flowing through the plurality of fluid connections, and
wherein at least a portion of at least one of the fluid distributor and the fluid collector includes a surge tank for the working fluid.

2. The heat exchanger unit according to claim 1, wherein the heat exchanger unit is a direct condenser unit or an indirect condenser unit.

3. The heat exchanger unit according to claim 1, wherein:
the fluid distributor has a fluid inlet for an inflow of the working fluid,
the fluid collector has a fluid outlet for an outflow of the working fluid,
wherein the surge tank is provided in at least the portion of the fluid collector, and
wherein the fluid distributor has a cross section having a maximum value at the fluid inlet and that decreases with increasing distance from the fluid inlet.

4. The heat exchanger unit according to claim 1, wherein:
the fluid collector includes a cover and a bottom (11),
a fluid-tight membrane is arranged between the cover and the bottom,
a first spatial region is disposed between the cover and the membrane,
a second spatial region is disposed between the membrane and the bottom, and
wherein the second spatial region is fluidically connected to the plurality of fluid connections.

5. The heat exchanger unit according to claim 4, wherein:
a fluid-permeable separating element is disposed in the second spatial region between the membrane and the bottom, and
the fluid-permeable separating element is structured and arranged to a pre-spatial region between the separating element and the bottom into which the membrane is blocked from penetrating.

6. The heat exchanger unit according to claim 4, wherein:
the second spatial region is structured and arranged to maintain a liquid level of the working fluid therein within a predefined level range during normal operation, and
wherein a fluid outlet of the fluid collector is arranged below the predefined level range.

7. The heat exchanger unit according to claim 6, wherein:
the fluid collector includes an additional condenser unit, and
wherein the additional condenser unit is arranged above the fluid outlet during operation.

8. The heat exchanger unit according to claim 7, wherein the additional condenser unit has a circuit that is filled with a working medium.

9. The heat exchanger unit according to claim 7, wherein:
the additional condenser unit includes a tank with a working medium,
wherein the working medium flows once through the additional condenser unit after a switching process and then escapes into the surroundings.

10. A fluid circuit of a motor vehicle, comprising:
a heat exchanger unit, the heat exchanger unit including:
a plurality of fluid connections communicating a through-flow of a working fluid;
a fluid distributor fluidically connected to the plurality of fluid connections, structured and arranged to distribute the working fluid among the plurality of fluid connections;
a fluid collector fluidically connected to the plurality of fluid connections, structured and arranged to collect the working fluid from the plurality of fluid connections
a surge tank for the working fluid provided in at least a portion of the fluid collector;
a fluid outlet for an outflow of the working medium;
wherein the fluid collector includes a fluid-tight membrane disposed therein that separates a first spatial region from a second spatial region;
wherein the second spatial region is fluidically connected to the plurality of fluid connections, and structured and arranged to hold a liquid phase of the working medium at a liquid level of a predefined level range during operation; and
wherein the fluid outlet is arranged below the predefined level range;
a fluid delivery device disposed downstream from the fluid outlet and
wherein the fluid delivery device is structured and arranged to only deliver a liquid phase of the working fluid.

11. A method for operating a fluid circuit, comprising:
delivering a mass flow of a liquid phase of a working medium via a fluid delivery device arranged downstream from a fluid outlet of a heat exchanger unit, and interrupting the mass flow delivered by the fluid delivery device upon inadequate condensation of the working fluid in the heat exchanger unit; and
halting operation of the fluid circuit upon interrupting the mass flow delivered by the fluid delivery device.

12. The method according to claim 11,
the mass flow delivered by the fluid delivery device is interrupted upon inadequate condensation of the working fluid in the heat exchanger unit the fluid delivery device substantially drawing in a gaseous phase of the working fluid.

13. The fluid circuit according to claim 10, wherein the heat exchanger unit is a direct condenser unit.

14. The fluid circuit according to claim 10, wherein the heat exchanger unit is an indirect condenser unit.

15. The fluid circuit according to claim 10, wherein the fluid outlet is provided at the fluid collector, and wherein the fluid distributor has a fluid inlet for an inflow of the working fluid into the heat exchanger unit.

16. The fluid circuit according to claim 15, wherein the fluid distributor has a cross section with a maximum value at the fluid inlet and decreases with increasing distance from the fluid inlet.

17. The fluid circuit according to claim 10, wherein the fluid collector further includes a cover and a bottom, wherein the first spatial region is disposed between the cover and the membrane, and the second spatial region is disposed between the membrane and the bottom.

18. The fluid circuit according to claim 17, wherein the fluid collector further includes a fluid-permeable separating element disposed in the second spatial region between the membrane and the bottom.

19. The fluid circuit according to claim 10, wherein the fluid collector further includes an additional condenser unit, and wherein the additional condenser unit is arranged above the fluid unlet in an installed position of the heat exchanger unit.

20. The fluid circuit according to claim 19, wherein the additional condenser unit has a circuit or a tank filled with a working medium.
